(19) United States
(12) Patent Application Publication
(10) Pub. No.: US 2006/0293468 A1
(43) Pub. Date: Dec. 28, 2006

(54) Polymer blend based on polycarbonate polyols

(75) Inventors: Thorsten Rische, Unna (DE); Thomas Munzmay, Dormagen (DE); Torsten Pohl, Leverkusen (DE); Uwe Klippert, Burscheid (DE); Steffen Hofacker, Odenthal (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/471,038

(22) Filed: Jun. 20, 2006

(30) Foreign Application Priority Data
Jun. 23, 2005 (DE) 102005029626.2

(51) Int. Cl. C08G 18/28

(52) U.S. Cl. 525/457

(57) ABSTRACT

Aqueous coating materials are provided. The materials comprise I) hydroxyl-free polyurethanes and/or polyurethane-ureas, II) ionically modified, hydroxyl-containing polyurethanes and/or polyurethane-ureas, and III) at least one crosslinker, characterized in that the components (I) and (II) comprise polycarbonate polyols which have at least 25% by weight of 1,4-butanediol as synthesis component. A process for preparing the coating materials, and their use as soft feel paint, is also provided.

### CROSS-REFERENCE TO RELATED APPLICATION

This application claims priority under 35 U.S.C. §119 (a-e) to German application DE 10 2005 029626, filed Jun. 23, 2005.

### FIELD OF THE INVENTION

The invention relates to aqueous coating materials based on polycarbonate polyols, to a process for preparing them and to their use as soft feel paint.

### BACKGROUND OF THE INVENTION

Polyurethane-polyurea dispersions (PU dispersions) and aqueous preparations of PU dispersions are known state of the art. One important field of use of aqueous preparations of ionically modified PU dispersions is in the area of the painting of plastics parts.

Aesthetic and technical requirements mean that plastics parts are usually painted in order to protect the plastic against external influences, such as sunlight, chemical, thermal and mechanical stress, to achieve particular colours and colour effects, to mask defects in the plastic's surface or to give the latter a pleasant feel (tactility). To improve the tactile properties of plastics parts, use has been made increasingly in recent years of what are called soft feel paints. “Soft feel effect” for the purposes of the present invention refers to a particular tactual sensation (tactility) of the painted surface; this tactility can be described using terms such as velvety, soft, rubbery and warm. In tune with the trend towards avoiding solvent emissions to the environment, recent years have seen the establishment of aqueous soft feel points based on polyurethane chemistry, as are disclosed, by way of example, in DE-A 44 06 159. As well as an excellent soft feel effect, these paints also produce coatings having good resistance and protection for the plastics substrate. It has since emerged, however, that these paints and coatings often have only an inadequate stability to hydrolysis.

The object of the present invention was therefore to provide coating materials which in addition to the abovementioned mechanical and tactile properties lead, in comparison to prior art coating materials, to coatings possessing significantly greater stability to hydrolysis.

As described for example in DE-A 44 06 159, plastics coating materials having the desired tactile soft feel properties are composed in part of PU dispersions containing no notable amounts of hydroxyl-functional groups.

DE-A 101 22 444 describes ionically and/or nonionically hydrophilicized polyurethane-polyurea (PU) dispersions that are stable to hydrolysis and are based on polycarbonate polyols and polytetramethylene glycol polyols. On a wide variety of substrates, in one-component coating materials, the dispersions lead to crease- and scratch-resistant coatings that are stable to hydrolysis. Use of these dispersions as soft feel paints, however, is not described.

### SUMMARY OF THE INVENTION

It has now been found that aqueous two-component (2K) coating materials which comprise not only non-functional PU polymers based on specific polycarbonate polyols and hydrophilic, hydroxyl-containing PU polymers based on specific polycarbonate polyols exhibit outstanding stability to hydrolysis and at the same time display the desired tactile properties.

The present invention accordingly provides aqueous coating materials comprising
I) hydroxyl-free polyurethanes and/or polyurethane-ureas,
II) ionically modified, hydroxyl-containing polyurethanes and/or polyurethane-ureas, and
III) at least one crosslinker,
   characterized in that the components (I) and (II) comprise polycarbonate polyols which have at least 25% by weight of 1,4-butanediol as synthesis component.

In the process for preparing the non-functional PU polymers (I), the synthesis components are selected from the group of components
A.1) polyisocyanates,
A.2) polymeric polyols having a number-average molecular weight of Mn 200 to 8000 g/mol, which comprise polycarbonate polyols having at least 25% by weight of 1,4-butanediol as synthesis component,
A.3) low molecular weight compounds of molar weight Mn 62 to 400 g/mol possessing in total two or more hydroxyl and/or amino groups,
A.4) compounds possessing one hydroxyl or amino group,
A.5) isocyanate-reactive, ionic or potentially ionic compounds, and
A.6) isocyanate-reactive, nonionic, hydrophilic compounds.

Suitable polyisocyanates of component A.1) are the aromatic, araliphatic, aliphatic or cycloaliphatic polyisocyanates which are known per se to the skilled person, have an NCO functionality of preferably ≧2 and may also contain iminooxadiazinedione, isocyanurate, uretdione, urethane, allophanate, biuret, urea, oxadiazinetrione, oxazolidinone, acylurea and/or carbodiimide structures. They may be used individually or in any desired mixtures of one another.

Examples of suitable polyisocyanates are hexamethylene diisocyanate (HDI), isophorone diisocyanate (IPDI), the isomeric dicyclohexylmethane 4,4′-diisocyanate or mixtures thereof with any desired isomer content and 1,4-cyclohexyl diisocyanate.

An example of a non-modified polyisocyanate having more than 2 NCO groups per molecule that may be mentioned is, for example, 4-isocyanatomethyl-1,8-octane diisocyanate (nonane triisocyanate).

Preference is given to polyisocyanates or polyisocyanate mixtures of the aforementioned kind that contain exclusively aliphatically and/or cycloaliphatically attached isocyanate groups.

Particular preference is given to hexamethylene diisocyanate, isophorone diisocyanate, the isomeric dicyclohexylmethane 4,4′-diisocyanate and also mixtures thereof.

Hydroxyl-containing polycarbonate polyols meeting the definition of component A.2) are obtainable by reacting carbonic acid derivatives, e.g. diphenyl carbonate, dimethyl carbonate or phosgene, with diols. The hydroxyl-functional poly-carbonate polyols A.2) to be used according to the invention have an average hydroxyl functionality of 1.6 to 4, preferably 1.8 to 3, and more preferably 1.9 to 2.3 and a number-average molecular weight of 240 to 8000 g/mol, preferably of 500 to 3000 g/mol, more preferably of 750 to 2500 g/mol. The polycarbonate polyols are preferably prepared according to the preparation process described in EP-A 1 404 740 (pp. 6-8, Examples 1-6) and EP-A 1 477 508 (p. 5, Example 3).

Examples of suitable diols include 1,3- and 1,4-butanediol, 1,6-hexanediol, 1,8-octanediol, 1,12-dodecanediol, neopentyl glycol, 1,4-bishydroxymethylcyclohexane, 2-methyl-1,3-propanediol and trimethylpentane-1,3-diol, the fraction of 1,4-butanediol being at least 25% by weight of the diol components used.

Preferably the diol component contains 45% to 100% by weight of 1,4-butanediol and 0% to 55% by weight of 1,6-hexanediol, more preferably 60% to 100% by weight of 1,4-butanediol and 0% to 40% by weight of 1,6-hexanediol.

The hydroxyl polycarbonates are preferably linear, but may also be branched where appropriate as a result of the incorporation of polyfunctional components, particularly low molecular weight polyols. Particularly preferred components A.2) are based on mixtures of 1,4-butanediol and 1,6-hexanediol and have an average hydroxyl functionality of 1.9 to 2.05.

Polyester polyols which have a molecular weight Mn of 400 to 6000 Da, more preferably of 600 to 3000 Da, can likewise be used by way of example as polymeric polyols A.2). Their hydroxyl number is generally 22 to 400 mg KOH/g, preferably 50 to 200 mg KOH/g and more preferably 80 to 160 mg KOH/g, and they have an OH functionality of 1.5 to 6, preferably of 1.8 to 4 and more preferably of 1.9 to 3.3.

Highly suitable examples are the conventional polycondensates of diols and also optionally polyols and dicarboxylic and also optionally polycarboxylic acids or hydroxycarboxylic acids or lactones. Instead of the free polycarboxylic acids it is also possible to use the corresponding polycarboxylic anhydrides or corresponding polycarboxylic esters of lower alcohols to prepare the polyesters. Examples of suitable diols are ethylene glycol, butane-1,4-diol, hexane-1,6-diol, neopentyl glycol. As polyols for optional use as well, mention may be made here, for example, of trimethylolpropane, glycerol or pentaerythritol.

Preferred suitable dicarboxylic acids include phthalic acid, isophthalic acid, terephthalic acid, tetrahydrophthalic acid, hexahydrophthalic acid, or adipic acid. Anhydrides of these acids are also suitable, where they exist. For the purposes of the present invention, consequently, the anhydrides are embraced by the term “acid”. Monocarboxylic acids as well, such as benzoic acid and hexanecarboxylic acid, can be used provided that the average functionality of the polyol is greater than 2. As a polycarboxylic acid which can also be used optionally, in relatively small amounts, mention may be made here of trimellitic acid.

Further suitable components A.2) are the polylactone and polyether polyols known from polyurethane chemistry, insofar as they correspond to the abovementioned criteria with respect to functionality and molecular weight.

The fraction of the hydroxypolycarbonates in the sum of the polyols from A.2) used to prepare the polymers (I) and (II), respectively, is 35 to 100% by weight, preferably 45 to 100% by weight and more preferably 65 to 100% by weight.

The low molecular weight polyols A.3) that are used for synthesizing the polyurethane resins generally have the effect of a stiffening and/or a branching of the polymer chain. The molecular weight is preferably situated between 62 and 200 Da. Suitable polyols may contain aliphatic, alicyclic or aromatic groups. Mention may be made here, by way of example, of the low molecular weight polyols having up to about 20 carbon atoms per molecule, such as ethylene glycol, diethylene glycol, 1,4-butanediol, 1,3-butylene glycol, cyclohexanediol, 1,4-cyclohexanedimethanol, 1,6-hexanediol, and also trimethylolpropane, glycerol or pentaerythritol.

Diamines or polyamines and also hydrazides can likewise be used as A.3), examples being ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic dihydrazide. Suitability as A.3) is also possessed in principle by compounds containing active hydrogen with a different reactivity towards NCO groups, such as compounds which in addition to a primary amino group also contain secondary amino groups or in addition to an amino group (primary or secondary) also contain OH groups.

The polyurethane resins I) and II) may also, where appropriate, include units A.4), which in each case are located at the chain ends and finish the said ends. These units are derived on the one hand from monofunctional compounds reactive towards NCO groups, such as monoamines, particularly mono-secondary amines or monoalcohols.

By ionically and potentially ionically hydrophilicizing compounds A.5) are meant all compounds which contain at least one isocyanate-reactive group and also at least one functionality, such as —COOY, —SO₃Y, —PO(OY)₂ (Y for example ═H, NH₄⁺, metal cation), —NR₂, —NR₃⁺ (R=H, alkyl, aryl), which on interaction with aqueous media enters into a pH-dependent dissociation equilibrium and in that way can have a negative, positive or neutral charge. Preferred isocyanate-reactive groups are hydroxyl or amino groups.

Suitably ionically or potentially ionically hydrophilicizing compounds meeting the definition of component A.5) are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and their salts such as dimethylolpropionic acid, dimethylolbutyric acid, hydroxypivalic acid, N-(2-aminoethyl)-β-alanine, 2-(2-aminoethylamino)ethanesulphonic acid, ethylenediaminepropylsulphonic or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of aliphatic diamines such as, for example, ethylenediamine (EDA) or isophoronediamine, IPDA and acrylic acid (EP-A 0 916 647, example 1) and the alkali metal and/or ammonium salts thereof; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and compounds which contain units which can be converted into cationic groups, amine-based units for example, such as N-methyldiethanolamine, as hydrophilic synthesis components. It is additionally possible to use cyclohexylamino-propanesulphonic acid (CAPS) such as in WO-A 01/88006, for example, as a compound meeting the definition of component A.5).

To synthesize the component (I), preferred compounds A.5) are those which possess carboxyl or carboxylate and/or sulphonate groups and/or ammonium groups. Particularly preferred ionic compounds A.5) are those containing carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, example 1) and also of dimethylolpropionic acid.

Suitable non-ionically hydrophilicizing compounds meeting the definition of component A.6) are, for example, polyoxyalkylene ethers which contain at least one hydroxyl or amino group. These polyethers include a fraction of 30% to 100% by weight of units derived from ethylene oxide.

The polyalkylene oxide polyether alcohols are either straight polyethylene oxide polyethers or mixed polyalkylene oxide polyethers at least 30 mol %, preferably at least 40 mol %, of whose alkylene oxide units are composed of ethylene oxide units. Preferred non-ionic compounds are monofunctional mixed polyalkylene oxide polyethers containing at least 40 mol % ethylene oxide units and not more than 60 mol % propylene oxide units.

For the PU polymers (I) it is preferred to use a combination of ionic and non-ionic hydrophilicizing agents meeting the definitions of components A.5) and A.6). Particularly preferred combinations are those of non-ionic and anionic hydrophilicizing agents.

It is preferred to use 5% to 45% by weight of component A.1), 50% to 90% by weight of component A.2), 1% to 30% by weight of the sum of compounds A.3) and A.4), 0 to 12% by weight of component A.5), 0 to 15% by weight of component A.6), the sum of A.5) and A.6) being 0.1% to 27% by weight and the sum of all components adding to 100% by weight.

It is particularly preferred to use 10% to 40% by weight of component A.1), 55% to 85% by weight of component A.2), 1% to 25% by weight of the sum of compounds A.3) and A.4), 0 to 10% by weight of component A.5), 0 to 10% by weight of component A.6), the sum of A.5) and A.6) being 0.1% to 20% by weight and the sum of all components adding to 100% by weight.

Very particular preference is given to using 15% to 40% by weight of component A.1), 60% to 85% by weight of component A.2), 1% to 20% by weight of the sum of compounds A.3), 0 to 8% by weight of component A.5), 0 to 10% by weight of component A.6), the sum of A.5) and A.6) being 0.1% to 18% by weight and the sum of all components adding to 100% by weight.

The coating materials of the invention comprise PU polymers (I) which are used in the form of their aqueous PU dispersion (I).

The process for preparing the aqueous PU dispersion (I) can be carried out in one or more stages in homogenous phase or, in the case of multi-stage reaction, partly in disperse phase. Following complete or partial polyaddition of A.1)-A.6) there is a dispersing, emulsifying or dissolving step. This is followed optionally by a further polyaddition or modification in disperse phase.

The aqueous PU dispersions (I) can be prepared using all of the prior art methods, such as the prepolymer mixing method, acetone method or melt dispersing method, for example. The PU dispersion (I) is prepared preferably by the acetone method.

For the preparation of the PU dispersion (I) by the acetone method the constituents A.2) to A.6), which should not contain any primary or secondary amino groups, and the polyisocyanate component A.1), for the preparation of an isocyanate-functional polyurethane prepolymer, are usually introduced in whole or in part as an initial charge and are diluted optionally with a solvent which is water-miscible but inert towards isocyanate groups and heated to temperatures in the range from 50 to 120° C. In order to accelerate the isocyanate addition reaction it is possible to use the catalysts that are known in polyurethane chemistry. Dibutyltin dilaurate is preferred.

Suitable solvents are the usual aliphatic, keto-functional solvents such as acetone or butanone, for example, which can be added not only at the beginning of the preparation but also in portions later on if desired. Acetone and butanone are preferred.

Subsequently any constituents from A.1)-A.6) that may not have been added at the beginning of the reaction are metered in.

In the case of the preparation of the polyurethane prepolymer the molar ratio of isocyanate groups to isocyanate-reactive groups is 1.0 to 3.5, preferably 1.1 to 3.0, more preferably 1.1 to 2.5.

The reaction of components A.1)-A.6) to form the prepolymer takes place partially or completely, but preferably completely. In this way polyurethane prepolymers containing free isocyanate groups are obtained, in bulk or in solution.

The preparation of the polyurethane prepolymers is followed or accompanied, if it has not already been carried out in the starting molecules, by partial or complete salt formation from the anionically and/or cationically dispersing groups. In the case of anionic groups this is done using bases such as tertiary amines, e.g. trialkylamines having 1 to 12, preferably 1 to 6, carbon atoms in each alkyl radical. Examples thereof are timethylamine, triethylamine, methyldiethylamine, tripropylamine and diisopropylethylamine. The alkyl radicals may, for example, also carry hydroxyl groups, as in the case of the dialkylmonoalkanolamines, alkyldialkanolamines and trialkanolamines. Neutralizing agents which can be used are optionally also inorganic bases, such as ammonia or sodium hydroxide and/or potassium hydroxide. Preference is given to triethylamine, triethanolamine, dimethylethanolamine or diisopropylethylamine.

The molar amount of the bases is between 50% and 100%, preferably between 70% and 100% of the molar amount of anionic groups. In the case of cationic groups, dimethyl sulphate or succinic acid is used. If only non-ionically hydrophilicized compounds I.6) containing ether groups are used, the neutralization step is omitted. Neutralization may also take place simultaneously with dispersing, with the dispersing water already containing the neutralizing agent.

Subsequently in a further step of the process, if it has not already taken place, or has taken place only partially, the resulting prepolymer is dissolved by means of aliphatic ketones such as acetone or butanone.

Thereafter, possible NH₂— and/or NH-functional components are reacted with the remaining isocyanate groups. This chain extension/termination may be carried out either in solvent prior to dispersing, during dispersing, or in water after the dispersing. Chain extension is preferably carried out prior to dispersing in water.

Where chain extension is carried out using compounds meeting the definition of A.5) and containing NH₂ or NH groups, the prepolymers are chain-extended preferably prior to dispersing.

The degree of chain extension, in other words the equivalent ratio of NCO— reactive groups of the compounds used for chain extension to free NCO groups of the prepolymer, is between 40% to 150%, preferably between 70% to 120%, more preferably between 80% to 120%.

The aminic components [A.3), A.4), A.5)] may optionally be used in water- or solvent-diluted form in the process of the invention, individually or in mixtures, with any sequence of the addition being possible in principle.

If water or organic solvents are also used as diluents then the diluent content is preferably 70% to 95% by weight.

The preparation of the PU dispersion (I) from the prepolymers takes place following chain extension. For that purpose either the dissolved and chain-extended polyurethane polymer is introduced into the dispersing water with strong shearing if desired, such as strong stirring, for example, or, conversely, the dispersing water is stirred into the prepolymer solutions. It is preferred to add the water to the dissolved prepolymer.

The solvent still present in the dispersions after the dispersing step is normally then removed by distillation. Removal actually during dispersing is likewise possible.

Depending on degree of neutralization and amount of ionic groups present, it is possible to make the dispersion very fine, so that it virtually has the appearance of a solution, although very coarse formulations are also possible, and are likewise sufficiently stable.

The solids content of the PU dispersion (I) is between 25% to 65%, preferably 30% to 60% and more preferably between 40% to 60%.

The ionically modified, hydroxyl-containing polyurethanes and/or polyurethane-ureas (II) contain 5% to 45% by weight of component A.1), 50% to 94.5% by weight of components A.2), 0% to 15% by weight of component A.3), 0.5% to 12% by weight of component A.5), 0% to 15% by weight of component A.6), the sum of all components adding up to 100% by weight.

The ionically modified, hydroxyl-containing polyurethanes and/or polyurethane-ureas (II) preferably contain 7.5% to 35% by weight of component A.1), 60% to 90% by weight of components A.2a), 0% to 10% by weight of components A.3), 2.5% to 7.5% by weight of component A.5), 0% to 12.5% by weight of component A.6), the sum of all components adding up to 100% by weight.

The ionically modified, hydroxyl-containing polyurethanes and/or polyurethane-ureas (II) very preferably contain 10% to 25% by weight of component II.1), 65% to 85% by weight of components A.2), 1.5% to 5% by weight of component A.3), 3% to 7% by weight of component A.5), 0% to 10% by weight of component A.6), the sum of all components adding up to 100% by weight.

Suitable components A.3) are only compounds which are OH-functional. Components A.4) are not used for the synthesis of polymers (II).

The ionically modified, hydroxyl-containing polyurethanes and/or polyurethane-ureas (II) preferably feature purely ionic hydrophilicization in accordance with the definition of components A.5). The coating materials of the invention comprise the ionically modified, hydroxyl-containing polyurethanes and/or polyurethane-ureas (II), which in the course of preparation are either converted into the aqueous form, and are therefore present as a dispersion, or alternatively are present as a solution in an optionally water-miscible solvent which is inert towards isocyanate groups.

The ionically modified, hydroxyl-containing polyurethanes and/or polyurethane-ureas (II) can be prepared by the customary prior art processes. The polyurethanes and/or polyurethane-ureas (II) differ from the PU polymers (I) in particular in the type of preparation and the type of hydrophilicizing. They contain carboxylic acid groups and/or sulphonic acid groups, preferably carboxylic acid groups, which may have been at least fractionally neutralized, as hydrophilic groups. For the preparation of the PU polymers (II) preference is therefore given as component A.5) to those possessing carboxyl and/or carboxylate groups. Particularly preferred ionic compounds A.5) are dihydroxycarboxylic acids, with especial preference being given to α,α-dimethylolalkanoic acids, such as 2,2-dimethylolpropionic acid, 2,2-dimethylolbutyric acid or dihydroxysuccinic acid, for example.

To prepare the ionically modified, hydroxyl-containing polyurethanes and/or polyurethane-ureas (II) it is usual to introduce, initially, components A.2), A.3), A.5) and optionally A.6), optionally together with a suitable catalyst and, where required, in an appropriate solvent, into a vessel. Added to this mixture at a temperature of 0 to 140° C., preferably 70 to 135° C. and more preferably at 90 to 130° C. is a polyisocyanate component A.1), after which the components are left to react until the reaction product is isocyanate-free. The amounts of components A.1) to A.6) employed are calculated such that for each equivalent of hydroxyl groups there is 0.45 to 0.95, preferably 0.55 to 0.90, more preferably 0.65 to 0.85 equivalent (eq) of isocyanate groups.

The preparation of the ionically modified, hydroxyl-containing polyurethanes and/or polyurethane-ureas (II) takes place preferably without the addition of organic solvents.

The acid groups incorporated in the prepolymer are at least fractionally neutralized. This can be done during or else after prepolymer preparation but also during or after dispersing in water, by adding suitable neutralizing agents (see also with regard to PU dispersion (I)). Examples of suitable neutralizing agents are triethylamine, triethanolamine, dimethylethanolamine, ethyldiisopropylamine or diisopropylethylamine. The neutralizing agent is generally used in a molar ratio with respect to the acid groups of the prepolymer of 0.3:1 to 1.3:1, preferably of 0.6:1 to 1.1:1.

Thereafter the hydroxyl-functional polyurethane is converted into an aqueous dispersion by addition of water or by introduction into water.

The resins of the PU polymers (II) that are obtainable in accordance with the procedure described above possess a number-average molecular weight Mₙ of 1000 to 30 000 Da, preferably of 1500 to 10 000 Da, an acid number of 10 to 80, preferably of 15 to 40 mg KOH/g and a hydroxyl group content of 0.5% to 6% by weight, preferably of 1.0% to 4%.

The PU dispersions (I) and (II) may furthermore comprise all additives that are known for PU dispersions such as, for example, antioxidants, light stabilizers and/or other auxiliaries and additives as well as fillers.

Also present in the coating materials of the invention are crosslinkers (III). Depending on the choice of crosslinker it is possible to prepare both one-component paints and two-component paints. By one-component paints for the purposes of the present invention are meant coating compositions wherein binder component and crosslinker component can be stored together without a crosslinking reaction taking place to any marked extent or any extent detrimental to the subsequent application. By two-component paints are meant for the purposes of the present invention coating compositions wherein binder component and crosslinker component have to be stored in separate vessels owing to their high reactivity. The two components are mixed only shortly before application, when they react generally without additional activation. Examples of suitable crosslinkers III) include blocked or non-blocked polyisocyanate crosslinkers, amide- and amine-formaldehyde resins, phenolic resins, aldehyde resins and ketone resins, such as for example phenol-formaldehyde resins, resoles, furan resins, urea resins, carbamate resins, triazine resins, melamine resins, benzoguanamine resins, cyanamide resins or aniline resins. Preference is given to polyisocyanates.

As crosslinker component (III) it is particularly preferred to use polyisocyanates having free isocyanate groups, since the resultant aqueous polyurethane paints display a particularly high level of paint properties. Examples of suitable crosslinkers (III) include paint polyisocyanates such as polyisocyanates containing uretdione, biuret, isocyanurate or iminooxadiazinedione groups and formed from hexamethylene diisocyanate, 1-isocyanato-3,3,5-trimethyl-5-isocyanatomethylcyclohexane or bis(4-isocyanatocyclohexane)methane.

Likewise provided by the present invention is a two-component paint comprising the coating materials of the invention.

The PU polymers (I) and (II) described here are generally sufficiently hydrophilic, so that the dispersibility even of hydrophobic crosslinkers from component (III) is ensured. If desired, however, it is also possible to add external emulsifiers such as are known to the skilled person.

Additionally, however, it is also possible in component (III) to use water-soluble or dispersible polyisocyanates such as are obtainable, for example, by modification with carboxylate, sulphonate and/or polyethylene oxide groups and/or polyethylene oxide/polypropylene oxide groups.

Also possible in principle, of course, is the use of mixtures of different crosslinker resins of the aforementioned kind in component (III).

Likewise provided by the present invention is a process for preparing the aqueous coating materials of the invention, characterized in that the PU polymers (I) and also the PU polymers (II) are dispersed in water and mixed with the crosslinker (III).

The ratio of the crosslinker (III) to the compounds of components (II) that are reactive with it is to be chosen so as to result in a ratio of crosslinker-reactive groups from (II) (e.g. OH groups) to the reactive groups of the crosslinker (NCO groups in the case of isocyanates) of 0.5:1.0 to 3.5:1.0, preferably 1.0:1.0 to 3.0:1.0 and more preferably of 1.0:1.0 to 2.5:1.0.

The mixture of components (I) and (II) contains preferably 5% to 95% by weight (with respect to solid resin), more preferably 25% to 75% by weight (with respect to solid resin) of component (II), and the amount of (I) is to be chosen such that the total amounts of (I) and (II) add up to 100% by weight (with respect to solid resin).

As customary paint auxiliaries and additives, the substances known to the skilled person may be present in the coating materials of the invention, such as defoamers, thickeners, pigments, dispersing assistants, matting agents, catalysts, anti-skinning agents, anti-settling agents and/or emulsifiers, and also additives which enhance the desired soft feel effect. The point in time during preparation at which the additives/auxiliaries are added to the coating materials of the invention or incorporated into them is unimportant.

The aqueous coating materials of the invention are suitable for all fields of use in which aqueous painting and coating systems subject to stringent requirements on the surface quality/resistance of the films are employed, such as the coating of surfaces of mineral building materials, the painting and sealing of wood and wood-based materials, the coating of metallic surfaces (metal coating), the coating and painting of asphaltic or bituminous coverings, the painting and sealing of various surfaces of plastics (plastics coating), and also as high-gloss varnishes.

A preferred use of the coating materials of the invention, however, is the production of soft feel effect paints, which ensure good hydrolysis resistance in conjunction with very good tactile properties. Such coating materials are used preferably in the painting of plastics or of wood, where curing takes place normally at temperatures between room temperature and 130° C. The two-component technology with non-blocked polyisocyanates as crosslinkers allows the use of comparatively low curing temperatures within the aforementioned range.

Accordingly soft feel paints comprising the coating materials of the invention are likewise provided by the present invention.

The aqueous coating materials of the invention are usually used in single-coat paints or in the clearcoat or topcoat film (topmost film) of multi-coat systems.

The coating can be produced by any of a wide variety of spraying methods such as, for example, air-pressure spraying, airless spraying or electrostatic spraying methods, using one-component or, where appropriate, two-component spraying units. The paints and coating materials comprising the binder dispersions of the invention can alternatively be applied by other methods, such as for example by brushing, rolling or knife coating.

The present invention likewise provides a multi-coat system characterized in that the topmost coat, which is a clearcoat or topcoat, comprises a soft feel paint comprising the coating materials of the invention.

### EXAMPLES

Unless indicated otherwise, all percentages are to be understood as referring to percent by weight.

Substances and Abbreviations Used:

Diaminosulphonate: NH₂—CH₂CH₂—NH—CH₂CH₂—SO₃Na (45% in water)
Desmophen® 3600: Difunctional polyether based on propylene oxide, number-average molecular weight 2000 g/mol, OH number 56 mg KOH/g (Bayer AG, Leverkusen, DE),
Polyether LB 25: (monofunctional polyether based on ethylene oxide/propylene oxide, number-average molecular weight 2250 g/mol, OH number 25 mg KOH/g (Bayer AG, Leverkusen, DE)
BYK® 348: Wetting agent (BYK-Chemie, Wesel, DE)
Tego-Wet® KL 245: Flow additive, 50% in water (Tegochemie, Essen, DE)
Aquacer® 535: Wax emulsion (BYK-Chemie, Wesel, DE)
Defoamer DNE: Defoamer (K. Obermayer, Bad Berleburg, DE)
Sillitin® Z 86: Filler (Hoffmann & Söhne, Neuburg, DE)
Talkum® IT extra: Matting agent (Norwegian Talc, Frankfurt, DE)
Bayferrox® 318 M: Colour pigment (black) (Bayer AG, Leverkusen, DE)
OK 412: Matting agent (Degussa, Frankfurt, DE)
Bayhydur® 3100: Hydrophilic, aliphatic polyisocyanate based on hexamethylene diisocyanate (HDI) with an isocyanate content of 17.4% (Bayer AG, Leverkusen, DE)
MPA: 1-methoxy-2-propyl acetate

The solids contents were determined in accordance with DIN-EN ISO 3251.

NCO contents, unless expressly stated otherwise, were determined volumetrically in accordance with DIN-EN ISO 11909.

### Example 1

### Polyester Polyol

A 15-1 reaction vessel with stirrer, heating apparatus and water separator with cooler was charged with 1281 g of phthalic anhydride, 5058 g of adipic acid, 6387 g of hexane-1,6-diol and 675 g of neopentyl glycol and this initial charge was heated to 140° C. in an hour under nitrogen. In a further 9 hours it was heated to 220° C. and condensed at that temperature until an acid number of less than 3 was reached. The polyester polyol thus obtained had a viscosity (determined as the efflux time of an 80% strength solution of the polyester in methoxypropyl acetate from a DIN 4 cup at 23° C.) of 54 seconds and an OH number of 160 mg KOH/g.

### Example 2

### Preparation of a Polycarbonate Diol Based on 1,4-butanediol and 1,6-hexanediol

1223 g of 1,4-butanediol and 535 g of 1,6-hexanediol were charged to a flask and heated to 100° C. Finally about 2 l/h nitrogen were introduced into the diol mixture, a vacuum of 20 mbar was applied, and the mixture was dewatered until (about 2 hours) the water content was ≦0.1%.

Thereafter, 0.44 g of ytterbium(III) acetylacetonate was added and the diol mixture was heated to 110° C. Subsequently 2297 g of dimethyl carbonate were run in over about 20 minutes and the reaction mixture was held under reflux for 24 h. Finally the temperature was raised to 150° C. and distillate produced was removed. This was followed by a further increase to 180° C., followed by a further distillation phase.

The reaction mixture was cooled to 130° C. and the pressure was lowered to 10 mbar. This was followed by a raising of the oil bath temperature from 130° C. to 180° C. over 2 h, during which the overhead distillation temperature did not exceed 60° C. After the temperature had reached 180° C. it was maintained at that level for 6 h.

The reaction mixture was subsequently cooled to 130° C. and the pressure lowered to 10 mbar. This was followed by a raising of the oil bath temperature from 130° C. to 180° C. over 2 h, during which the overhead distillation temperature did not exceed 60° C. After the temperature had reached 180° C. it was maintained at that level for 6 h. The reaction mixture was cooled to room temperature and the product characteristics were determined.

The product is a polycarbonate diol having a hydroxyl number of 57.3 mg KOH/g and a viscosity of 115 Pas at 23° C.

### Example 3

### Preparation of a Polycarbonate Diol Based on 1,4-butanediol and 1,6-hexanediol

1239 g of 1,4-butanediol and 542 g of 1,6-hexanediol were charged to a flask and heated to 100° C. in an oil bath. Finally about 2 l/h nitrogen were introduced into the diol mixture, a vacuum of 20 mbar was applied, and the mixture was dewatered until (about 2 hours) the water content was <0.1%.

Thereafter, 0.44 g of ytterbium(III) acetylacetonate was added and the diol mixture was heated to 110° C. Subsequently 2180 g of dimethyl carbonate were run in over about 20 minutes and the reaction mixture was held under reflux for 24 h. Finally the temperature was raised to 150° C. and distillate produced was removed. This was followed by a further increase to 180° C., followed by a further distillation phase.

The reaction mixture was cooled to 130° C. and the pressure was lowered to 10 mbar. This was followed by a raising of the oil bath temperature from 130° C. to 180° C. over 2 h, during which the overhead distillation temperature did not exceed 60° C. After the temperature had reached 180° C. it was maintained at that level for 6 h.

The reaction mixture was subsequently cooled to 130° C. and the pressure lowered to 10 mbar. This was followed by a raising of the oil bath temperature from 130° C. to 180° C. over 2 h, during which the overhead distillation temperature did not exceed 60° C. After the temperature had reached 180° C. it was maintained at that level for 6 h. The reaction mixture was then cooled to room temperature and the product characteristics were determined.

The product is a polycarbonate diol having a hydroxyl number of 113.4 mg KOH/g and a viscosity of 13 600 mPas at 23° C.

### Example 4

### Comparison for Component I

Bayhydrol® PR 240: anionically hydrophilicized PU dispersion based on polyester with a solids content of 40% and an average particle size of 100-300 nm (Bayer AG, Leverkusen, DE)

### Example 5

### Comparison for Component I)

Bayhydrol® PR 340: anionically hydrophilicized PU dispersion based on a poly-carbonate diol, which comprises exclusively 1,6-hexanediol as diol synthesis component, with a solids content of 50% and an average particle size of 100-300 nm (Bayer AG, Leverkusen, DE)

### Example 6

### Non-Functional PU Dispersion (Component I) (Inventive)

64.0 g of Desmophen® 3600, 196.8 g of Example 2, and 10.9 g of polyether LB 25 are heated to 75° C. Subsequently at 75° C. over the course of 5 minutes 48.7 g of hexamethylene diisocyanate are added and the mixture is heated to 100° C. and stirred at 100° C. until the theoretical NCO value is reached. The finished prepolymer is dissolved with 568.1 g of acetone at 50° C. and subsequently a solution of 1.2 g of hydrazine hydrate, 7.70 g of diaminosulphonate, 2.20 g of 1,2-diaminoethane and 82.3 g of water is metered in over the course of 5 minutes. The subsequent stirring time amounts to 30 minutes. The dispersion is carried out by addition of 408.4 g of water. After removal of the solvent by vacuum distillation, a storage-stable dispersion having a solids content of 40.0% is obtained.

### Example 7

### Hydroxy-Functional PU Dispersion of the Prior Art (Comparison)

Bayhydrol® XP 2429: Aliphatic, hydroxy-functional polyester-polyurethane dispersion of the prior art, prepared using a polycarbonate diol based exclusively on 1,6-hexanediol as the diol component, with a solids content of 55% (Bayer AG, Leverkusen, DE)

### Example 8

### Hydroxy-Functional PU Dispersion (Component II)

A 6-1 reaction vessel with cooling, heating and stirring apparatus was charged under a nitrogen atmosphere with 1170 g of the polyester polyol from Example 1 which was then heated, together with 1140 g of polycarbonate diol from Example 2, 90 g of trimethylolpropane, 120 g of dimethylolpropionic acid and 3.8 g of tin(II) octoate, to 130° C., and the mixture was homogenized for 30 minutes. It was then cooled to 80° C., 480 g of hexamethylene diisocyanate were added with vigorous stirring, the temperature was raised to 140° C., utilizing the exothermic heat, and the mixture was held at that temperature until NCO groups were no longer detectable.

The polyurethane thus obtained was then cooled to 90-100° C., 47 g of dimethylethanolamine (degree of neutralization 60%) were added, and the mixture was homogenized for 15 minutes and dispersed with 2270 g of demineralized water. The aqueous polyurethane resin dispersion thus obtained had an OH content (in 100% form) of 1.4%, an acid number (in 100% form) of 16.8, an average particle size of 110 nm and a viscosity of about 2020 mPas (23° C.; D=40 s⁻¹) with a solids content of 51.2% by weight.

### Example 9

### Hydroxy-Functional PU Dispersion (Component II)

A 6-1 reaction vessel with cooling, heating and stirring apparatus was charged under a nitrogen atmosphere with 1170 g of the polyester polyol from Example 1 which was then heated, together with 1140 g of polycarbonate diol from Example 3, 90 g of trimethylolpropane, 120 g of dimethylolpropionic acid, 125 g of N-methylpyrrolidone and 3.8 g of tin(II) octoate, to 130° C., and the mixture was homogenized for 30 minutes. It was then cooled to 80° C., 480 g of hexamethylene diisocyanate were added with vigorous stirring, the temperature was raised to 140° C., utilizing the exothermic heat, and the mixture was held at that temperature until NCO groups were no longer detectable.

The polyurethane thus obtained was then cooled to 90′-100° C., 39 g of dimethylethanolamine (degree of neutralization 50%) were added, and the mixture was homogenized for 15 minutes and dispersed with 2270 g of demineralized water. The aqueous polyurethane resin dispersion thus obtained had an OH content (in 100% form) of 1.4%, an acid number (in 100% form) of 16.3, an average particle size of 150 nm and a viscosity of about 1680 mPas (23° C.; D=40 s⁻¹) with a solids content of 55.9% by weight.

Technical Application Section

Using Examples 1-9, the following performance tests are conducted into the production of soft feel coatings:

The stock paint is produced, following prior dispersion, by dispersing using a laboratory shaker. The temperature of the millbase ought not to exceed 40° C. Subsequently stir in OK 412 for about 10 minutes. After crosslinking, the paint system is adjusted to a flow time (DIN ISO 2431, 5 mm nozzle) of about 30 s and sprayed conventionally onto Bayblend® T 65. The dry film coat thickness amounts to between 30 and 40 μm.

TABLE 1
Performance Examples 10-15 (comparative)

| | Example | | | | | |
|---|---|---|---|---|---|---|
| | 10 | 11 | 12 | 13 | 14 | 15 |
| Component I: | | | | | | |
| Example 4 | 137.5 | | 127.5 | 139.8 | | |
| Example 5 | | 100.0 | | | 100.0 | |
| Example 6 | | | | | | 100.2 |
| Component II: | | | | | | |
| Example 7 | 100.0 | 72.7 | | | | 72.7 |
| Example 8 | | | 100.0 | | 73.3 | |
| Example 9 | | | | 100.0 | | |
| Additives/pigments: | | | | | | |
| Defoamer DNE | 0.8 | 0.5 | 0.7 | 0.8 | 0.5 | 0.5 |
| Tego ® Wet KL 245 | 1.1 | 0.9 | 1.1 | 1.2 | 0.9 | 0.9 |
| Byk ® 348 | 1.5 | 1.4 | 1.4 | 1.5 | 1.4 | 1.4 |
| Aquacer ® 535 | 5.6 | 4.0 | 5.2 | 5.7 | 4.0 | 4.0 |
| Sillitin ® Z 86 | 19.1 | 13.9 | 17.9 | 19.3 | 13.9 | 13.9 |
| Talkum IT extra | 15.2 | 11.1 | 14.3 | 15.5 | 11.1 | 11.1 |
| Bayferrox ® 318 M | 50.8 | 37.0 | 47.6 | 51.5 | 37.0 | 37.0 |
| OK 412 | 10.2 | 7.4 | 9.5 | 10.3 | 7.4 | 7.4 |
| Component III: | | | | | | |
| Bayhydur ® 3100, 75% | 22.7 | 16.5 | 22.7 | 22.7 | 16.6 | 16.5 |
| in MPA | | | | | | |

| | |
|---|---|
| NCO/OH ratio | 1.5 |

Application conditions: about 23° C. and 55% relative humidity.

Drying conditions: 10 min/RT, 30 min/80° C. and about 16 h/60° C. ageing

TABLE 2
Performance Examples 16-17 (inventive)

Example

| | 16 | 17 |
|---|---|---|
| Component I: | | |
| Example 6 | 140.1 | 100.2 |
| Component II: | | |
| Example 8 | | 73.3 |
| Example 9 | 100.0 | |
| Additives/pigments | | |
| Defoamer DNE | 0.8 | 0.5 |
| Tego ® Wet KL 245 | 1.2 | 0.9 |
| Byk ® 348 | 1.5 | 1.4 |
| Aquacer ® 535 | 5.7 | 4.0 |
| Sillitin ® Z 86 | 19.3 | 13.9 |
| Talkum IT extra | 15.5 | 11.1 |
| Bayferrox ® 318 M | 51.5 | 37.0 |
| OK 412 | 10.3 | 7.4 |
| Component III: | | |
| Bayhydur ® 3100, 75% in MPA | 22.7 | 34.6 |

| | |
|---|---|
| NCO/OH ratio | 1.5 |

Application conditions: about 23° C. and 55% relative humidity.

Drying conditions: 10 min/RT, 30 min/80° C. and about 16 h/60° C. ageing

TABLE 3
Hydrolysis resistance after 72 h at 90° C. and about 90% relative humidity

| | | | | after 72 h hydrolysis and | | |
|---|---|---|---|---|---|---|
| | 0 value | | | 1 h regeneration at RT | | |
| | P | | | P | | |
| Example | hardness¹ | CC² | Softening³ | hardness¹ | CC² | Softening³ |
| 10 | B | 0-1 | 0-1 | 6B | 0 | 4-5 |
| 11 | B | 0-1 | 0-1 | 3B | 0 | 0-1 |
| 12 | HB | 0 | 0-1 | 3B | 0 | 3 |
| 13 | HB | 0-1 | 0-1 | B | 1 | 2 |
| 14 | HB | 2 | 0 | 2B | 0 | 0 |
| 15 | B | 1 | 2 | 4B | 0 | 1-2 |
| 16 | B | 0 | 0 | B | 0-1 | 0-1 |
| 17 | B | 1 | 0 | B | 0 | 0-1 |
| ¹Pencil hardness testing: The pencil hardness method is a test to determine the paint film hardness. Pencils differing in hardness (6B to 7H) are tested on painted specimens as follows at room temperature: the tip of the pencil is ground horizontally so as to give a planar, circular area. At an angle of 45° the pencil is then pushed over the paint film under test, in the course of which the force | | | | | | |
| # applied ought to remain as constant as possible. The pencil hardness value is determined when the paint surface shows damage for the first time. | | | | | | |

²Determined in accordance with DIN EN ISO 2409 (0 = best value, 5 = worst value)
³Test of film softening (fingernail test): The film softening is determined by means of the film nail test. The assessment of softening by the fingernail test is as follows: not scratchable = 0 (best value); scratchable down to the substrate = 5 (worst value)

Pencil Hardness Testing:
The pencil hardness method is a test to determine the paint film hardness. Pencils differing in hardness (6B to 7H) are tested on painted specimens as follows at room temperature: the tip of the pencil is ground horizontally so as to give a planar, circular area. At an range of 45° the pencil is then pushed over the paint film under test, in the course of which the force applied ought to remain as constant as possible. The pencil hardness value is determined when the paints surface shows damage for the first time.
Determined in accordance with DIN EN ISO 2409 (O=best value, 5=worst value)
Test of Film Softening (Fingemail Test):
The film softening is determined by means of the film nail test. The assessment of softening by the fingernail test is as follows: not scratchable=(best value); scratchable down to the substrate=5 (worst value)

All coatings according to Examples 10-17 have a comparable hardness and excellent tactility. The results from Table 3 demonstrate, however, that, in contrast to the inventive coatings (Examples 16-17), after 72 h under hydrolysis at 90° C. and 90% relative humidity, however, the comparative examples exhibit considerable film softening (degradation owing to hydrolysis (compare Table 3, P hardness/softening columns)), whereas the coatings from the inventive Examples 16-17 exhibit no softening at all, that is to say possessing significantly greater stability to hydrolysis.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous coating material comprising
I) hydroxyl-free polyurethanes and/or polyurethane-ureas,
II) ionically modified, hydroxyl- and/or amino-containing polyurethanes and/or polyurethane-ureas, and
III) at least one crosslinker,
Wherein the components (I) and (II) comprise polycarbonate polyols which have at least 25% by weight of 1,4-butanediol as a synthesis component.

2. Aqueous coating material according to claim 1, wherein the polycarbonate polyols contain 45% to 100% by weight of 1,4-butanediol and 0% to 55% by weight of 1,6-hexandiol as synthesis components.

3. Aqueous coating material according to claim 1, wherein the polycarbonate polyols contain 60% to 100% by weight of 1,4-butanediol and 0% to 40% by weight of 1,6-hexandiol as synthesis components.

4. Aqueous coating material according to claim 1, wherein the polycarbonate polyols have an average hydroxyl functionality of 1.6 to 4.

5. Aqueous coating material according to claim 1, wherein the polycarbonate polyols comprise a mixture of 1,4-butanediol and 1,6-hexanediol as synthesis components and have an average hydroxyl functionality of 1.9 to 2.05.

6. Aqueous coating material according to claim 1, wherein component II) is a polyurethane polymer based on a polyester urethane and a polycarbonate polyol.

7. Aqueous coating material according to claim 1, wherein the crosslinker (III) is a polyisocyanate having free isocyanate groups and is derived from aliphatic or cycloaliphatic isocyanates.

8. Two-component paint comprising the coating materials according to claim 1.

9. A coating on the surface of mineral building materials, metallic surfaces or asphaltic or bituminous coverings, paints and sealants for wood and wood-based materials or plastics surfaces, or high-gloss varnishes comprising the coating material of claim 1.

10. A soft feel paint on plastic substrates or wood substrates comprising the coating material of claim 1.

11. Soft feel paint comprising the coating materials according to claim 1.

12. Multi-coat system with a topmost coat, which is a clearcoat or topcoat film, and a soft feel paint according to claim 11.
